(19) United States
(12) Patent Application Publication
(10) Pub. No.: US 2024/0005711 A1
(43) Pub. Date: Jan. 4, 2024

(54) Access Control

(71) Applicant: APPLE INC., Cupertino, CA (US)

(72) Inventors: Ryan J. Dunn, Santa Cruz, CA (US); Duane M. Petrovich, San Francisco, CA (US); Eric L. Chien, Sunnyvale, CA (US); Julia M. Sohnen, Sunnyvale, CA (US); Nicholas A. Sims, San Francisco, CA (US); Ryan J. Garrone, San Francisco, CA (US); Sarah E. Carey, San Diego, CA (US); Devyn M. Byrnes, Cupertino, CA (US)

(21) Appl. No.: 18/214,571

(22) Filed: Jun. 27, 2023

Related U.S. Application Data
(60) Provisional application No. 63/356,732, filed on Jun. 29, 2022.

(51) Int. Cl. G07C 9/00; G07C 9/26; G06V 40/16; G06V 10/141

(52) U.S. Cl. CPC G07C 9/00563; G07C 9/26; G07C 9/00309; G06V 40/172; G06V 10/141; G07C 2009/00769

(57) ABSTRACT

A method for selectively granting access to an access-controlled space includes obtaining an image of the person requesting access using a camera that is located inside the access-controlled space, and permitting an authorized user of the access-controlled space to grant authorization using the image.

### CROSS-REFERENCE TO RELATED APPLICATIONS

This application claims the benefit of, and priority to, U.S. Provisional Application No. 63/356,732, filed on Jun. 29, 2022, the content of which is hereby incorporated herein by reference in its entirety for all purposes.

### FIELD

The present disclosure relates generally to the field of controlling access to a physical space.

### BACKGROUND

Access to physical spaces may be controlled by door locks that are operated, for example, using physical keys or electronic devices.

### SUMMARY

One aspect of the disclosure is a non-transitory computer-readable storage device including program instructions executable by one or more processors that, when executed, cause the one or more processors to perform operations. The operations include detecting an access request made by a person who is located outside of an access-controlled space. The access-controlled space is defined by a structure having a window and a door. The method also includes, in response to the access request, obtaining an image of the person using a camera that is located inside the access-controlled space, wherein the camera is oriented toward the window, such that the person is viewable by the camera through the window. The method also includes transmitting the image of the person to an authorized user of the access-controlled space, and upon receiving an approval indication from the authorized user of the access-controlled space, granting access to the access-controlled space to the person.

In some implementations, the access request is made by the person using an interface device that is associated with the structure. In some implementations, the access request is made by the person using a device that is associated with the person. In some implementations, the operations further include changing an operating state of a variable light transmission component associated with the window to increase light transmission through the window prior to obtaining the image of the person. In some implementations, changing the operating state of the variable light transmission component is performed in response to a command received from the authorized user. In some implementations, changing the operating state of the variable light transmission component is performed automatically in response to detecting that a light level is below a threshold light level. In some implementations, granting access to the access-controlled space to the person includes transitioning the door from a locked state to an unlocked state.

Another aspect of the disclosure is an apparatus that includes a structure having a window and a door, the structure defining an access-controlled space, and a camera inside the structure and having a field of view of the outside of the structure. The apparatus also includes one or more processors that are coupled to the camera. The one or more processors are configured to detect an access request made by a person who is located outside of an access-controlled space, in response to the access request, obtain an image of the person using the camera, wherein the camera is oriented toward the window, such that the person is viewable by the camera through the window, transmit the image of the person to an authorized user of the access-controlled space, and upon receiving an approval indication from the authorized user of the access-controlled space, grant access to the access-controlled space to the person.

In some implementations, the access request is made by the person using an interface device that is associated with the structure. In some implementations, the door comprises a door handle and the one or more processors are configured to detect an attempt to open the door using the door handle while the door is in a locked state, wherein the detected access request is the attempt to open the door using the door handle. In some implementations, the access request is made by the person using an electronic device that is associated with the person and that is in wireless data communication with the apparatus.

In some implementations, the window comprises a variable light transmission component, and the one or more processors are further configured to change an operating state of the variable light transmission component associated with the window to increase light transmission through the window while obtaining the image of the person. In some implementations, changing the operating state of the variable light transmission component is performed in response to a command received from the authorized user. In some implementations, changing the operating state of the variable light transmission component is performed automatically in accordance with detecting that a light level is below a threshold light level.

In some implementations, granting access to the access-controlled space to the person includes transitioning the door from a locked state to an unlocked state. In some implementations, the structure further comprises a structural pillar, and the camera is located on the structural pillar of the structure. In some implementations, the structure further comprises an exterior panel, and the camera is disposed on the exterior panel of the structure.

Another aspect of the disclosure is a method that includes detecting an access request made by a person who is located outside of an access-controlled space, the access-controlled space defined by a structure having a window and a door. The method also includes, in response to the access request, obtaining an image of the person using a camera that is located inside the access-controlled space, wherein the camera is oriented toward the window, such that the person is viewable by the camera through the window. The method also includes transmitting the image of the person to an authorized user of the access-controlled space, and upon receiving an approval indication from the authorized user of the access-controlled space, granting access to the access-controlled space to the person.

### BRIEF DESCRIPTION OF THE DRAWINGS

FIG. 1 is a schematic illustration of an access-controlled space.

FIG. 2 is a block diagram of a process for controlling access.

FIG. 3 is a block diagram of a control system.

### DETAILED DESCRIPTION

The disclosure herein relates to controlling access to a physical space in a structure. In some situations, a person may need to enter an access-controlled space when an authorized person is not present to give them access. In the implementations disclosed herein, an authorized user is able to grant the person access from a remote location. When an access request is sent to the authorized person, images or other sensor outputs can be sent that represent the person who is requesting access. To reduce the need for additional hardware components to implement this functionality, a camera and/or other sensors that are located inside the access-controlled space for the purpose of observing conditions inside the access-controlled space may be used to capture the images or other sensor outputs through a window of the structure. Thus, for example, some implementations described herein include obtaining an image of a person who is requesting access to an access-controlled space using a camera that is located inside the access-controlled space, wherein the camera is oriented toward a window such that the person is viewable by the camera through the window and is able to capture an image of the person. The image is then transmitted to an authorized person, such as an owner of the access-controlled space, who is able to grant or deny access from a remote location.

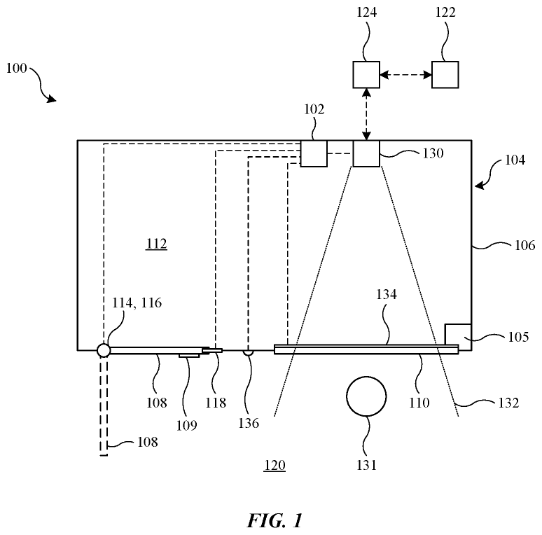

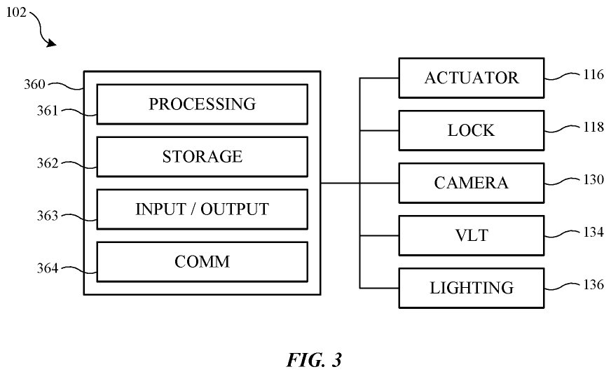

FIG. 1 is a schematic illustration of an access-controlled space 100. Hardware and software components are associated with the access-controlled space 100 in order to implement access-control functions, as will be described herein, and references herein to the access-controlled space 100 may refer to the physical space in combination with the hardware and/or software components that implement the access-control functionality. A control system 102 is configured to selectively grant access to the access-controlled space 100. The control system 102 may be a computing device that includes one or more processors that are operable to execute computer program instructions that are stored in a memory in order to perform access control functions relative to the access-controlled space 100. In some implementations, the control system 102 employs a computing device 360 described with reference to FIG. 3, below.

The access-controlled space 100 is defined by a structure 104 having walls, 106, a door 108, and a window 110. The access-controlled space 100 may correspond to an interior 112 of the structure 104. The structure 104 is configured such that the interior 112 may be made generally inaccessible when the door 108 and or the window 110 are closed. Accordingly, persons who are not authorized to enter the access-controlled space 100 may be excluded from it by physical security measures associated with the access-controlled space 100, such as the walls 106, the door 108 and the window 110. The walls 106 may be constructed in any suitable manner. In one implementation, the walls 108 may be or include exterior panels that are located on and define a portion of the exterior surface of the structure 104.

The door 108 is movable between a closed position and an open position (shown in dashed lines). The door 108 may be in a locked state when in the closed position to restrain movement from the closed position toward the open position, and may be transitioned from the locked state to an unlocked state to unlocked in order to allow movement of the door 108 from the closed position toward the open position. The door 108 may include a door handle 109 that is configured to allow movement of the door 108 between the closed and open positions, including latching the door 108 relative to the structure 104 and locking the door 108 to restrain movement between the closed and open positions.

To allow movement of the door 108 with respect to the walls 106 of the structure 104, the door 108 may be connected to the walls 106 by a hinge 114. As an example, the hinge 114 maybe a conventional door hinge that supports the door 108 for pivoting between the closed position and the open position with respect to the walls 106. Other types of support structures may be used to connect the door 108 for movement with respect to the walls 106, such as a sliding support structure that allows the door to slide between the closed position in the open position.

An actuator 116 may be connected to the door 108 to cause movement of the door 108 between the closed position and the open position in response to a control signal, for example, from the control system 102. As an example, the actuator 116 may include a rotary electric motor or a linear electric motor that is operably connected to the door 108 to cause movement of the door 108. The actuator 116 may allow the door 108 to be opened automatically by the control system 102 and the actuator 116 may allow the door 108 to be closed automatically by the control system 102. Thus, the control system 102 may be configured to open the door 108 using the actuator 116, and the control system 102 may be configured to close the door 108 using the actuator 116.

The door lock 118 may be provided to transition the door 108 between the locked state and the unlocked state. The door lock 118 may include a locking actuator that is controllable in response to a control signal, for example, from the control system 102. Thus, the control system 102 may be configured to lock the door 108 using the door lock 118, and the control system 102 may be configured to unlock the door 108 using the door lock 118.

The window 110 is fixed to the walls 106 of the structure 104 in the illustrated implementation and may therefore be immovable relative to the walls 106. In alternative implementations, the window 110 may be movable between a closed position and an open position, and may be lockable to restrain movement of the window 110 from the closed position to the open position. In another alternative implementation, the window 110 may be connected to the door 108 (either fixed or movably) and is configured to move with the door 108 when the door 108 moves between the closed and open positions with respect to the walls 106 of the structure 104. The window 110 is either translucent or transparent to allow an outside space 120 to be viewed from the interior 112 of the structure 104.

The control system 102 may be configured to grant access to the access-controlled space 100 when a user device 122 is present. The user device 122 is associated with an authorized user of the access-controlled space 100, who may be an owner of the access-controlled space 100, a person who has been granted authorization to use the access-controlled space 100, or a person who is otherwise authorized to use the access-controlled space. As examples, the user device may be a smart cellular phone, a key fob, or another type of electronic device that can be carried by a user.

In the implementations that are described herein, the user device 122 is located at a remote location relative to the access-controlled space 100, and access to the access-controlled space 100 is not granted based on presence of the user device 122 near the access-controlled space 100. The user device 122 may communicate with the control system 102 using a service 124 that is able to communicate with the control system 102 and is configured to facilitate certain aspects of use of the access-controlled space 100. The service 124 may be configured to communicate with the control system 102 and the user device 122 using a wired or wireless data transmission connection of any type, such as a local area network connection, a cellular data network connection, the Internet, and/or direct communications using any type of short range communications system. As an example, the service 124 may be configured to send and receive information, commands, and requests to and from the control system 102 and the user device 122. Thus, the service 124 may be configured to transfer information between the control system 102 and the user device 122. The service 124 may also be configured to make determinations relating to the access-controlled space 100 and/or the user device 122.

In some implementations, the service 124 may store a user profile for the user who is associated with the user device 122. The user profile may be used to determine that the user is authorized to use the access-controlled space 100. The user profile may store additional information, such as preferences. Gathering and storage of information in a user profile or other form is only performed with consent from the user, and is optional.

The control system 102 is operably connected to a camera 130 that is configured to obtain an image of a person 131 that is located outside the access-controlled space 100 in the outside space 120. A camera 130 is located inside the access-controlled space 100, such as by being located within the interior 112 of the structure 104, and the camera is oriented toward the window 110, such that the person 131 is viewable by the camera 130 through the window 110. As an example, the camera 130 may be coupled to and supported by one of the walls 106 of the structure 104. As a further example, in which one or more of the walls 106 is configured as an exterior panel of the structure 104, the camera 130 may be disposed on an exterior panel of the structure 104. The camera 130 may alternatively be supported in other ways, such as by being suspended from a roof the structure 104, supported by an object that is located in the interior 112 of the structure 104, or in any other suitable way. As another example, the camera 130 may be coupled to a portion of the structure 104, such as a structural pillar 105 of the structure 104 that is coupled to the window 110. In such an example, the camera 130 disposed between the structure 104 and the window 110, such as in a space defined between the structure 104 and the window 110. Thus, the structure 104 may further comprise one or more pillars, such as the structural pillar 105, and the camera 130 may be located on the structural pillar 105 of the structure 104. As another example, the camera 130 may be disposed in a space defined by a housing or other component that is coupled to the window 110.

The camera 130 may be a still camera that is configured to output one or more images or the camera 130 may be a video camera that is configured to output a series of images in the form of video frames. The images that are output by the camera 130 may be digital images comprising pixels arranged in a grid, each pixel defined by values corresponding to intensity, color components, and/or other information. The camera 130 is a visible spectrum camera but may alternatively be an infrared spectrum camera or may include multiple cameras of varying types.

The camera 130 has a field of view 132 that corresponds to an area that is shown in images that are output by the camera 130. The camera 130 is configured to be oriented toward the window 110 by virtue of a fixed mount by which the camera 130 is oriented toward the window 110 or by a movable mount that allows the camera 130 to move (e.g., by rotating using actuators under control by the control system 102) such that that the camera 130 is oriented toward the window 110. When the camera 130 is oriented toward the window 110, at least part of the window 110 and at least part of the outside space 120 (e.g., at the exterior of the access-controlled space 100) is located within the field of view 132 and therefore viewable in images that are generated by the camera 130 and output to the control system 102. Thus, the camera 130 may be oriented toward the window 110 so that the camera 130 is able to obtain images of the outside space 120 through the window 110. The camera 130 is also able to obtain images of objects and persons who are located outside of the access-controlled space 100, such as in the outside space 120, by viewing the objects and persons through the window 110.

As will be described here, the camera 130 is used by the control system 102 in the course of determining whether to grant or deny access to the access-controlled space. However, the camera 130 may be used for other functions, such as for monitoring conditions inside the access-controlled space 100 or for identifying that an unauthorized access to the access-controlled space 100 has occurred, for example, by breakage of the window 110.

A variable light transmission component 134 (e.g., a VLT component) is operatively connected to the window 110. As one example, the variable light transmission component 134 may be a film that is adhered to a surface of the window 110. As another example, the variable light transmission component 134 may be a layer that is incorporated in a laminated structure of the window 110. The variable light transmission component 134 is configured to affect the manner in which light passes through it. The variable light transmission component 134 is controllable, for example, by a control signal that is applied to the variable light transmission component 134 by the control system 102 or applied by control electronics associated with the variable light transmission component 134 in response to a command transmitted by the control system 102. As an example, the variable light transmission component 134 may include an active layer having a changeable optical property that changes in correspondence with a voltage that is applied to the active layer by electrodes or other electric current distribution structures. As examples, the variable light transmission component 134 may be implemented using electrochromic devices, suspended-particle devices, or polymer-dispersed liquid-crystal devices.

The variable light transmission component 134 may be changed between a transparent state and a non-transparent state. In one implementation, the variable light transmission component 134 is a variable tint component that is configured to vary the amount of light that is passed through it, between a fully transparent state and a fully opaque state. In another implementation the variable light transmission component 134 is a variable haze component that is configured to vary a degree by which light is scattered as it passes through it, between a fully transparent state and a maximum scattering state, in which the variable light transmission component 134 appears translucent and light passes through it, but the degree of light scattering applied by the variable light transmission component 134 obscures visibility through the variable light transmission component 134.

Alighting device 136 may be provided to illuminate the outside space 120. As an example, the lighting device 136 may be connected to an exterior surface of the walls 106 of the structure 104. The lighting device 136 is connected to the control system 102 in a manner that allows the control system 102 to change an illumination state if the lighting device 136 between an illuminated state and a non-illuminated state, and optionally to change an illumination intensity of the lighting device 136.

The control system 102 is configured to communicate with and/or control the actuator 116, the door lock 118, the variable light transmission component 134, and the lighting device 136. The control system 102 is also configured to communicate with the service 124. The control system 102 is also configured to communicate with the user device 122, either directly, or using the service 124.

The control system 102, the user device 122, the service 124, and/or other devices may be configured to perform processes in support of providing access to the access-controlled space 100 the structure 104. Such processes can be implemented using one or more computing devices, such as the computing device 360 of FIG. 3. As an example, the processes described herein and the steps thereof may be implemented in the form of computer program instructions that are executable by one or more computing devices, wherein the instructions, when executed by the one or more computing devices, cause the one or more computing devices to perform functions that correspond to the steps of the processes.

The access-controlled space 100 may take various forms. As one example, the access-controlled space 100 may be a fixed structure, such as a home or a place of business. As another example, the access-controlled space 100 may be a movable structure, such as a vehicle that includes motion actuators that are configured to move the access-controlled space 100, such as by driving on a road in implementations in which the access-controlled space 100 is configured as a road-going vehicle. In implementations in which the access-controlled space 100 is defined by a vehicle, the access-controlled space 100 may be, as examples, in a passenger cabin, in a cargo compartment, or in another space that is not accessible from the exterior of the vehicle.

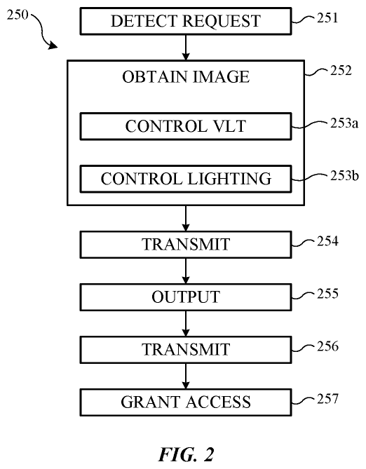

FIG. 2 is a block diagram that shows a process 250 for controlling access to the access-controlled space 100. The process 250 includes detecting an access request, obtaining an image in response to the access request, transmitting the image to an authorized user of the access-controlled space 100, and granting access to the access-controlled space upon receiving an approval indication from the authorized user of the access-controlled space 100.

Operation 251 includes detecting an access request. The access request is detected by the control system 102. The access request is made by the person 131 who is located outside of the access-controlled space 100. As previously described, the access-controlled space 100 is defined by the structure 104, which includes the door 108 and the window 110.

The access request represents the person 131 asking the authorized user associated with the user device 122 for permission to enter and/or use the access-controlled space 100. As an example, the access request of operation 251 may be made by the person 131 while the person 131 is located in the outside space on the exterior of the structure 104 that defines the access-controlled space 100.

In some implementations, the access request is made by the person 131 using an interface device that is associated with the structure 104 that defines the access-controlled space 100. The interface device may be a component that is associated with (e.g., included in or operably connected to) the control system 102. As an example of an access request made using an interface device that is associated with the structure 104, the access request may include operation, by the person 131, of a button that is associated with the structure 104. As an example of an access request made using an interface device that is associated with the structure 104, the access request may include physical contact, by the person 131, with a portion of the structure 104. The physical contact may include touching, by the person 131, a portion of the structure 104 or a contact-based gesture, such as knocking on a portion of the structure 104. Physical contact with the structure 104 may be detected using the camera 130, a three-dimensional sensing device, a capacitive sensor device, a motion sensing device (e.g., an inertial measurement unit) or another type of sensing device. As an example of an access request made using an interface device that is associated with the structure 104, the access request may include a verbal command that is spoken by the person 131, such as a verbal statement asking for access to the access-controlled space 100, which is perceived by a sensor such as a microphone that is associated with the control system 102 and is interpreted by the control system 102, for example, using a conventional speech recognition algorithm.

In some implementations, the access request is made by the person 131 when the person makes a non-contacting gesture, such as a hand movement or arm movement that signifies an intent to request access to the access-controlled space. The non-contacting gesture omits contact, by the person, with any portion of the structure 104. The non-contacting gesture may be detected by the control system 102 using the camera 130.

In some implementations, the access request is made by the person 131 using a device that is associated with the person 131. The device associated with the person 131 may be a computing device, such as a smart cellular telephone, and may be implemented in the manner described with respect to the computing device 360.

In some implementations, the access request is made based on presence of the person 131 near the access-controlled space 100, for example, when the person 131 is standing adjacent to the door 108 or the window 110 of the access-controlled space 100. In this context, presence may be defined as location of the person 131 in a pre-defined area. In such an implementation, presence is interpreted as the access-request and the control system 102 may proceed as in other implementations where an explicit request for access was made. Presence of the person near the access-controlled space may be determined using the camera 130 in combination with a detection algorithm that is configured to determine that a person is present in an image. In some implementations, the access request is determined based on presence of the person 131 near the access-controlled space in combination with determining that a gaze direction of the person's eyes is oriented toward part of the access-controlled space 100, such as when the person 131 is looking at the door 108 or when the person is looking at the camera 130 (e.g., the person 131 makes eye contact with the camera).

In some implementations, the access request is made based on detection of operation of the door handle 109 of the door 108. In particular, control system 102 may be configured to detect an attempt to open the door 108 using the door handle 109 while the door 108 is in the locked position, and the attempt to open the door 108 using the door handle 109 may be interpreted as an access request. To detect the attempt to open the door 108, sensors coupled to the door handle 109 may generate a signal that is output to the control system 102 when the door handle 109 is operated, or another sensor may be used to detect operation of the door handle 109, such as the camera 130, another camera, a lidar device, another three-dimensional sensing system, or another suitable sensor.

Operation 252 is performed in response to receiving the access request in operation 251, and includes obtaining an image of the person 131. The image of the person 131 is obtained using the camera 130, which is located inside the access-controlled space 100 and is oriented toward the window 110, such that the person 131 is viewable by the camera 130 through the window 110. The control system 102 may cause the camera 130 to obtain the image of the person 131, such as by transmitting a command to the camera 130 in response to the access request. The image that is captured by the camera 130 may be provided by the camera 130 to the control system 102.

Operation 252 may include sub-operation 253a, which is optional. Sub-operation 253a includes changing the operating state of the variable light transmission component 134 to increase light transmission through the window 110 prior to obtaining the image of the person 131. This allows the person 131 to be viewed through the window by the camera 130 without being partially or fully obscured by the variable light transmission component 134. As an example, the operating state of the variable light transmission component 134 may be changed to modify the operating state from a fully opaque state or partially opaque state to a fully transparent state prior to obtaining the image in operation 252. As another example, the operating state of the variable light transmission component 134 may be changed to modify the operating state from a maximum scattering state or a partial scattering state to a fully transparent state prior to obtaining the image in operation 252. Changing the operating state of the variable light transmission component 134 may be performed by transmitting a command from the control system 102 to the variable light transmission component 134.

Operation 252 may include sub-operation 253b, which is optional. Sub-operation 253a includes changing the operating state of the lighting device 136 to increase a light level prior to obtaining the image of the person. The operating state of the lighting device 136 may be changed from an off state to an on state, or an illumination intensity of the lighting device 136 may be increased. Changing the operating state of the lighting device 136 may be performed by transmitting a command from the control system 102 to the lighting device 136.

With respect to sub-operations 253a and 253b, changing the operating state of the variable light transmission component 134 and/or the lighting device 136 may be performed in response to a command received from the authorized user, for example, from the user device 122 that is associated with the authorized user. An image may be sent to the user device 122 according to operation 252, and a user interface may be presented that displays the image and also allows control of the operating states of the variable light transmission component 134 and the lighting device 136. Thus, the authorized user associated with the user device 122 may view the image, and then send a command to the control system 102 using the user device 122 if the view presented in the image does not provide a sufficient basis for determining whether to grant or deny access to the access-controlled space 100. Alternatively, changing the operating state of the variable light transmission component 134 or changing the operating state of the lighting device 136 may be performed automatically in response to detecting that a light level (e.g., of light incident on the person 131) is below a threshold light level. The light level may be determined by the camera 130 or by another sensor that is associated with the access-controlled space 100 and/or the control system 102.

With respect to sub-operations 253a and 253b, changing the operating state of the variable light transmission component 134 and/or the lighting device 136 may be performed in response to a command received from the authorized user, for example, from the user device 122 that is associated with the authorized user.

With respect to sub-operations 253a and 253b, the operating state of the variable light transmission component 134 and/or the lighting device 136 may be returned to its original state (e.g., automatically by the control system 102) after the image of the person 131 is obtained in operation 252 or after approval or denial of access to the access-controlled space 100.

Operation 254 includes transmitting the image of the person 131 that was obtained in operation 252 to the authorized user of the access-controlled space 100. This may be done, for example, by transmitting the image from the control system 102 to the user device 122 that is associated with the authorized user of the access-controlled space 100. The image of the person 131 is transmitted to the user device 122 as part of the access request. The image of the person 131 may be transmitted from the control system 102 to the user device 122 using any suitable communications protocol. The image may be transmitted via the service 124 or otherwise.

Operation 255 includes outputting a request for approval at a device associated with the user of the access-controlled space 100, such as the user device 122. As an example, the image of the person 131 that was obtained in operation 252 may be displayed on a display screen of the user device 122 along with a prompt that asks the authorized user whether to grant access to the access-controlled space 100 or deny access to the access-controlled space 100. The image and the prompt may be displayed together in the form of a user interface that includes user interface elements (e.g., buttons) corresponding to grant and denial of access to the access-controlled space 100, the user interface elements being selectively operated by the user of the user device 122 to express grant or denial of access.

Operation 256 is performed by the user device 122 in response to receiving user input at the user device 122 expressing a user intention to grant or deny access to the access-controlled space 100, and includes transmitting an indication of approval or denial in response to the access request. The indication of approval or denial is transmitted from the user device 122 to the control system 102, and may be transmitted via the service 124. For example, if the authorized user grants access in operation 255, an approval indication is transmitted from the user device 122 to the control system 102, and if the authorized user does not grant access in operation 255, a denial indication may be transmitted from the user device to the control system 102.

Operation 257 is performed by the control system 102 in response to receiving the approval indication from the authorized user of the access-controlled space 100, for example, from the user device 122, and includes granting access to the access-controlled space 100 to the person 131 who is associated with the access request made in operation 251. Granting access to the access-controlled space 100 may include transitioning the door 108 from the locked state to the unlocked state, which may be performed by the control system 102 by transmitting a command to the door lock 118 that causes the door lock 118 to unlock the door 108. Granting access to the access-controlled space 100 may include automatically moving the door 108 from the closed position to the open position using the actuator 116, for example, by transmitting a command from the control system 102 to the actuator 116 that causes operation of the actuator 116 to move the door 108 from the closed position to the open position.

In an alternative implementation, operation 254, operation 255, and operation 256 may be omitted, and a grant or denial of access to the access-controlled space 100 may be determined by an automated access control process performed by the control system 102 or the service 124. The automated access control process may grant or deny access using a biometric recognition technique (e.g., including facial recognition and/or other techniques) using images from the camera 130 and optionally also using three-dimensional sensor outputs to determine an identify of the person 131. The control system 102 and/or the service 124 may grant access to the access-controlled space 100 if the identity of the person 131 matches the identity of a known authorized person, and may deny access to the access-controlled space 100 if the identity of the person 131 does not match the identity of a known authorized person.

FIG. 3 is a block diagram of the control system 102. The control system 102 is implemented using the computing device 360, and is connected to controllable components that are associated with the access-controlled space, such as the actuator 116, the door lock 118, the camera 130, the variable light transmission component 134, and the lighting device 136. The computing device 360 is an example of a device that can be used to implement computing functions of the control system 102, and can also be used to implement other computing devices and systems that are described herein. The computing device may include one or more processing devices 361, storage 362, input/output devices 363, and a communications device 364, which may be interconnected in a conventional manner, such as by a system bus.

To execute program instructions, the processing devices 361 may by be or include one or more conventional processing devices, or one or more or more special-purpose processing devices. As examples, the processing devices 361 may include a central processing unit, a graphics processing unit, a system on a chip device, an application specific integrated circuit, or a field programmable gate array. The processing devices 361 may incorporate short-term storage in the form of one or more volatile, high-speed, short-term information storage devices, such as random-access memory.

Long-term storage is provided by the storage 362, which is a non-volatile information storage device, such as a flash memory, a hard drive, or a solid-state drive. The input/output devices 363 are configured to receive inputs and to generate outputs, for example, to facilitate interactions with a human user of the computing device 360. Examples of devices that may be included in the input/output devices 363 may include a keyboard, a mouse, a touch-based input device, a non-contact gesture-based input device, an audio input device, a motion tracking input device, an audio output device, and a visual output device (e.g., a conventional display screen). The communications device 364 facilitates exchange of information with other devices through direct or indirect (e.g., networked) connections according to any suitable wired or wireless communications protocol.

The computing device 360 is operable to store, load, and execute computer program instructions. When executed by the computing device 360, the computer program instructions cause the computing device 360 to perform operations. The operations that can be performed by the computing device 360 may include obtaining information. Examples of obtaining information include accessing the information from a storage device, accessing the information from short-term memory, receiving a wired or wireless transmission that includes the information, receiving signals from an input device that represent user inputs, and receiving signals from sensors that represent observations made by the sensors. The operations that can be performed by the computing device 360 may include making a determination. Examples of making a determination include comparing a value to a threshold, comparing states to conditions, and making a calculation using data of any type. The operations that can be performed by the computing device 360 may also include transmitting information, for example, to a remote system. The operations that can be performed by the computing device 360 may also include outputting a signal to cause an external device to perform an operation. As examples, a computing device 360 may control a component, cause a sensor to take a measurement, cause a camera to capture an image, or cause operation of an actuator in a specified manner.

An aspect of the above-described technology contemplates the use of data available from various sources in controlling access to a physical space. Implementers are reminded, to the extent that implementations of the present technology involve data that identifies a specific person, to comply with applicable privacy policies and/or practices in their implementations. These policies and practices include those generally recognized as meeting or exceeding industry or governmental requirements for maintaining personal information data private and secure. Such policies should be easily accessible by users, and should be updated as the collection and/or use of data changes. Personal information from users should be collected, if collected at all, for legitimate and reasonable uses of the entity. Such collection and use should occur after receiving the informed consent of the users. Additionally, such entities should consider taking any needed steps for safeguarding and securing access to such personal information data and ensuring that others with access to the personal information data adhere to their privacy policies and procedures.

What is claimed is:

1. A non-transitory computer-readable storage device including program instructions executable by one or more processors that, when executed, cause the one or more processors to perform operations, the operations comprising:
detecting an access request made by a person who is located outside of an access-controlled space, the access-controlled space defined by a structure having a window and a door;
in response to the access request, obtaining an image of the person using a camera that is located inside the access-controlled space, wherein the camera is oriented toward the window, such that the person is viewable by the camera through the window;
transmitting the image of the person to an authorized user of the access-controlled space; and
upon receiving an approval indication from the authorized user of the access-controlled space, granting access to the access-controlled space to the person.

2. The non-transitory computer-readable storage device of claim 1, wherein the access request is made by the person using an interface device that is associated with the structure.

3. The non-transitory computer-readable storage device of claim 1, wherein the access request is made by the person using a device that is associated with the person.

4. The non-transitory computer-readable storage device of claim 1, the operations further comprising:
changing an operating state of a variable light transmission component associated with the window to increase light transmission through the window prior to obtaining the image of the person.

5. The non-transitory computer-readable storage device of claim 4, wherein changing the operating state of the variable light transmission component is performed in response to a command received from the authorized user.

6. The non-transitory computer-readable storage device of claim 4, wherein changing the operating state of the variable light transmission component is performed automatically in response to detecting that a light level is below a threshold light level.

7. The non-transitory computer-readable storage device of claim 1, wherein granting access to the access-controlled space to the person includes transitioning the door from a locked state to an unlocked state.

8. An apparatus, comprising:
a structure having a window and a door, the structure defining an access-controlled space;
a camera inside the structure and having a field of view of the outside of the structure; and
one or more processors, coupled to the camera, configured to:
detect an access request made by a person who is located outside of the access-controlled space,
in response to the access request, obtain an image of the person using the camera, wherein the camera is oriented toward the window, such that the person is viewable by the camera through the window,
transmit the image of the person to an authorized user of the access-controlled space, and
upon receiving an approval indication from the authorized user of the access-controlled space, grant access to the access-controlled space to the person.

9. The apparatus of claim 8, wherein the access request is made by the person using an interface device that is associated with the structure.

10. The apparatus of claim 8, wherein the door comprises a door handle and the one or more processors are configured to detect an attempt to open the door using the door handle while the door is in a locked state, wherein the detected access request is the attempt to open the door using the door handle.

11. The apparatus of claim 8, wherein the access request is made by the person using an electronic device that is associated with the person and that is in wireless data communication with the apparatus.

12. The apparatus of claim 8, wherein the window comprises a variable light transmission component, and wherein the one or more processors are further configured to:
change an operating state of the variable light transmission component associated with the window to increase light transmission through the window while obtaining the image of the person.

13. The apparatus of claim 12, wherein changing the operating state of the variable light transmission component is performed in response to a command received from the authorized user.

14. The apparatus of claim 12, wherein changing the operating state of the variable light transmission component is performed automatically in accordance with detecting that a light level is below a threshold light level.

15. The apparatus of claim 8, wherein granting access to the access-controlled space to the person includes transitioning the door from a locked state to an unlocked state.

16. The apparatus of claim 8, wherein the structure further comprises a structural pillar, and the camera is located on the structural pillar of the structure.

17. The apparatus of claim 8, wherein the structure further comprises an exterior panel, and the camera is disposed on the exterior panel of the structure.

18. A method, comprising:
detecting an access request made by a person who is located outside of an access-controlled space, the access-controlled space defined by a structure having a window and a door;
in response to the access request, obtaining an image of the person using a camera that is located inside the access-controlled space, wherein the camera is oriented toward the window, such that the person is viewable by the camera through the window;
transmitting the image of the person to an authorized user of the access-controlled space; and
upon receiving an approval indication from the authorized user of the access-controlled space, granting access to the access-controlled space to the person.

19. The method of claim 18, wherein the access request is made by the person using an interface device that is associated with the structure.

20. The method of claim 18, wherein the access request is made by the person using a device that is associated with the person.
